(19) United States
(12) Patent Application Publication
(10) Pub. No.: US 2002/0168967 A1
(43) Pub. Date: Nov. 14, 2002

(54) Establishing a local wireless intranet for retail customers

(76) Inventor: Edward O. Clapper, Tempe, AZ (US)

Correspondence Address: Timothy N. Trop, TROP, PRUNER & HU, P.C., 8554 KATY FWY, STE 100, HOUSTON, TX, 77024-1805, US

(21) Appl. No.: 09/854,778

(22) Filed: May 14, 2001

(51) Int. Cl. H04M 3/42

(52) U.S. Cl. 455/414; 455/456; 455/406

(57) ABSTRACT

A wireless retail customer intranet may be established within a retail facility. Customers may use personal digital assistants with wireless transceivers to communicate with a server operated by the retail facility visited by the customers. The server may provide communications to the customers based on the customer's current location or otherwise. In addition, the customers may use the store-based intranet to communicate with other customers. Those communications may be in the form of text or audio messages in some cases. Through the use of the wireless digital device, greater interactivity between store operators and retail customers may be achieved.

### BACKGROUND

This invention relates generally to local area networks or intranets.

A local area network enables a plurality of processor-based systems to communicate with one another and with peripheral devices such a printers. A wireless intranet enables communication without the use of cumbersome cable connections.

In general, interaction between customers and between customers and sales personnel in large “bricks and mortar” retail facilities may be relatively limited. Because of the large number of customers, it is not possible in many cases for sales personnel to interact individually with each customer. At best, customers may be advised through a loudspeaker system of special opportunities and other information.

In many cases, greater interactivity may be possible between customers and retail service or product providers in an on-line environment. Customer e-mails may facilitate communication. On-line catalogs may facilitate the provision of information to customers.

Thus, there is a need to enable greater interactivity between customers in retail facilities and the retail facility owner or operator. In many cases, it may be easier for a customer in a retail facility to get help by using a wireless device to access information over the Internet than it is to actually get the information on site.

Thus, there is a need for better ways for improving interactivity between customers and “bricks and mortar” retail facilities.

### BRIEF DESCRIPTION OF THE DRAWINGS

FIG. 1 is a front elevational view of a personal digital assistant in accordance with one embodiment of the present invention;

FIG. 2 is a bottom plan view of the personal digital assistant shown in FIG. 1;

FIG. 3 is a block depiction of one embodiment of the personal digital assistant shown in FIG. 1;

FIG. 4 is a block depiction of a wireless intranet in accordance with one embodiment of the present invention;

FIG. 5 is a flow chart for software that may be utilized by the personal digital assistant shown in FIG. 1 in accordance with one embodiment of the present invention; and

FIG. 6 is a flow chart for software that may be utilized by the server in the wireless intranet shown in FIG. 4 in accordance with one embodiment of the present invention.

### DETAILED DESCRIPTION

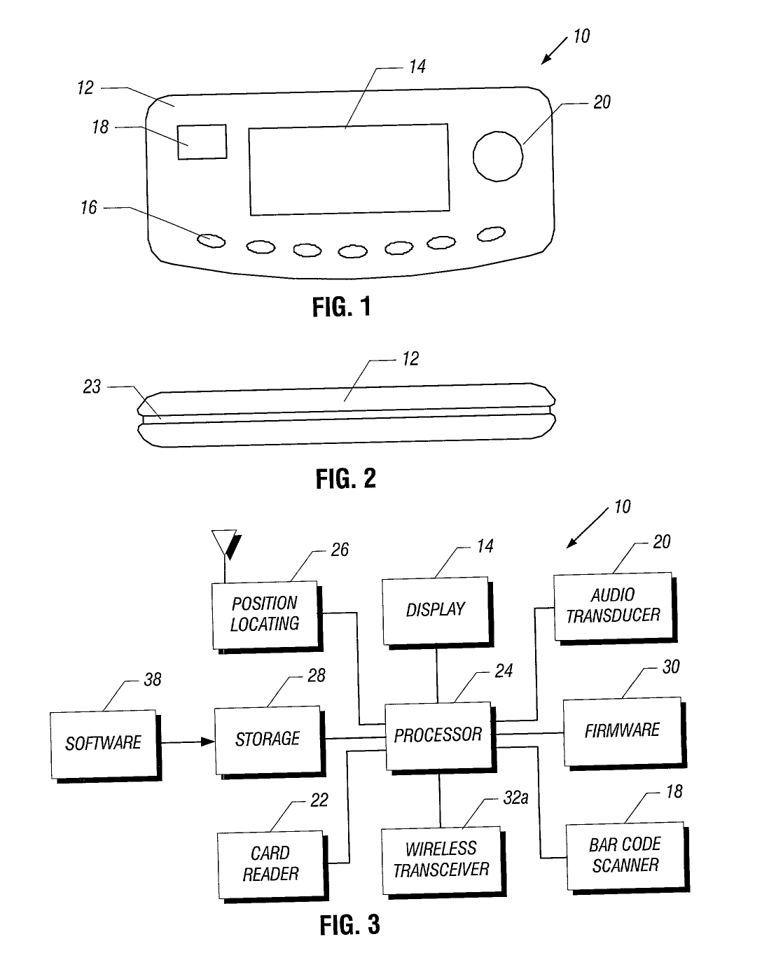

Referring to FIG. 1, a personal digital assistant or PDA 10, for use by retail customers, may include a housing 12 with a display 14. As used herein, the term PDA refers to any portable, processor-based system. A plurality of user programmable or preprogrammed operators 16 may be provided. A user programmable operator 16 enables automatic implementation of specific functions such as Internet access, audio communications or any of a variety of other functions.

Also included on the housing 12 is a bar code scanner 18 and an audio transducer 20 in one embodiment. The bar code scanner 18 may be utilized to scan products in a retail facility in order to identify a particular product. Once identified, information may be obtained about the product such as its price and availability. The audio transducer 20 facilitates voice and sound communications through the PDA 10 in a fashion described in more detail later.

The PDA 10 may be battery powered, portable or handheld, and may include a wireless transceiver to enable wireless communications with a local area network or intranet. In one embodiment, an internal antenna (not shown) allows wireless communication with a proximate server. For example, an IEEE 802.11 standard protocol wireless local area network may be implemented that includes the PDA 10. See Institute of Electrical and Electronics Engineers (IEEE), New York, N.Y. 802.11 (1997).

Turning next to FIG. 2, one edge of the housing 12 may include a card reader slot 23. The card reader slot 23 receives a smart card or credit card to be scanned. In one embodiment of the present invention, the user may be recognized when the user scans a credit card or other identifying card, including a magnetic stripe, through the card reader slot 23.

In one embodiment of the present invention, the user may own the PDA 10 and may bring the PDA 10 to a retail facility such as a department store, a discount store, a hardware store, or a supermarket. In such case, the card reader 22 may be unnecessary.

In another embodiment of the present invention, the PDA 10 may be made available to customers who arrive at such a retail facility. A customer may be identified by swiping the customer's identification card through the card reader 22. The PDA 10 may then immediately initialize the system for that user, identifying the user's name from the magnetically stored information on the card and correlating the user's identity to a database for each registered user. This database may include information specifically provided by the user to the database (such as the information from the swiped card) as well as information about the habits and practices of a particular user of a PDA 10 gleaned from use of a PDA 10, in some embodiments.

One embodiment to the PDA 10, shown in FIG. 3, includes a processor 24. The processor 24 communicates with the display 14, the audio transducer 20, a card reader 22 and the bar code scanner 18. In addition, firmware 30, including an operating system and a basic input/output system (BIOS), may be provided for controlling the operation of the PDA 10.

The processor 24 may communicate with a wireless transceiver 32a. The wireless transceiver 32a enables wireless communications between the PDA 10 and a proximate local area network. The local area network, not shown in FIG. 3, may include a server that likewise includes a wireless transceiver like the transceiver 32a, in one embodiment.

The processor 24 may also include a storage 28, such as a flash memory, as one example. The storage 28 may store application software 38 for implementing certain functions of the PDA 10.

Finally, the processor 24 may be coupled to a position locating device 26. The position locating device 26 may use radio frequency triangulation techniques or global positioning system techniques, as two examples, to locate the position of the PDA 10 within a retail facility. Thus, the PDA 10 may be part of a network that knows, at any given time, where the PDA 10 is located. The position locating device 26 may indicate where the PDA 10 is located, the processor 24 may receive this information through the wireless transceivers 32, and the processor 24 may cause this information to be broadcast to other devices in a fashion to be described hereinafter.

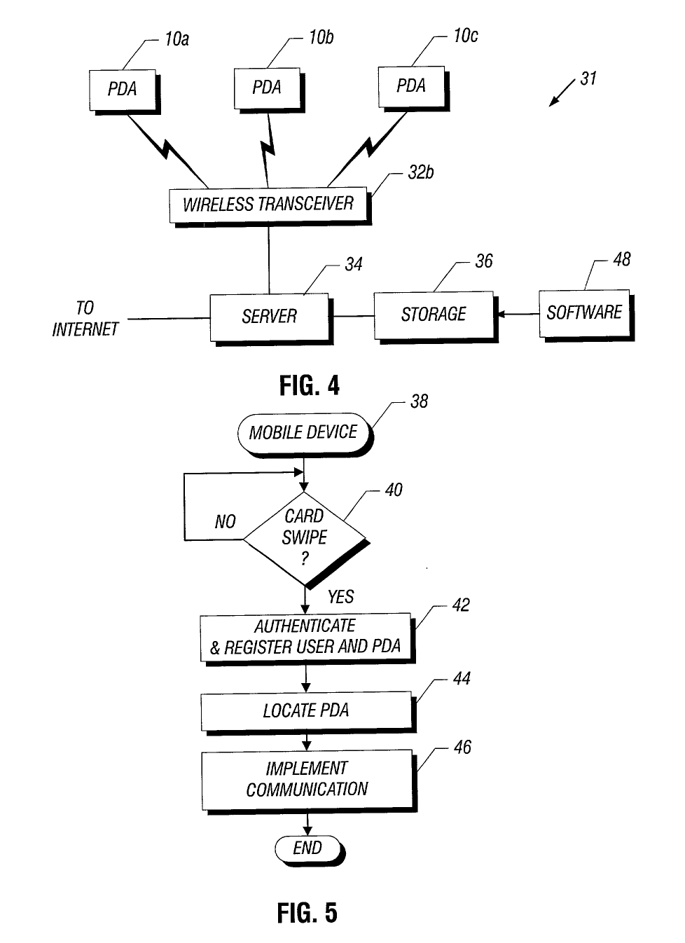

Turning now to FIG. 4, a wireless intranet 31 may include a plurality of PDAs 10a, 10b, and 10c. Each of these PDAs 10 may be carried by a different customer in a retail facility. Those PDAs may communicate with a server 34 as a local area network through a wireless transceiver 32b. The wireless transceiver 32b receives wireless communications from each PDA 10 and provides the corresponding information to a server 34.

In this way, a retail facility may implement a wireless intranet wherein communications between various users of PDAs 10 may be forwarded by the server 34 among the various customers. In addition, any customer using a PDA 10 may make queries to the server 34. These queries may seek additional information about products, product locations, store hours, and other useful information to retail customers.

In some cases, broadcasts may be sent or pushed by the server 34 to users of PDAs 10. These broadcasts may be personalized to particular users 10 based on information from a database maintained for each user. Such databases may include information about the user including frequency of store visits, purchase amounts, types of products purchased, interests, and any other information of interest.

The server 34 may include a connection to the Internet to enable the server 34 to access information over the Internet and to provide that information to a PDA 10 making a request for information. Alternatively, the server 34 may itself push Internet information to the PDAs 10. The server 34 is a processor-based system that includes a storage 36 that stores the software 48. The software 48 is an application program that implements the wireless retail intranet.

Any given customer with access to a PDA 10 may wirelessly communicate with other PDA 10 users. These communications may be in the form of electronic mail or may be via audio or voice communications. With voice communications, the voice inputs to the audio transducer 20 may be converted into digital files and sent through the transceiver 32a to the transceiver 32b. The server 34 may then route the communications to an appropriate receiver. Each of a plurality of customers in the store may then be addressed (for example by name or other identifier) by any user who knows other customers who are present within the retail facility.

The PDA 10 may facilitate scanning prices, locating products on a store map relative to the user's present position (which may also be indicated on the map), receiving dynamic directions, locating the position of friends who are also carrying PDAs 10, obtaining product information, keeping track of the running totals of purchases, and even taking advantage of virtual or instant coupons, to mention a few examples.

In one embodiment of the present invention, each PDA 10 may be authenticated using an integral identification such as a silicon serial number that may be stored, for example, in the firmware 30. The PDA 10 is then authenticated for local use within the intranet 31. Temporary aliasing may be provided to connect a PDA 10 to a user's remote e-mail.

In addition, the owner or operator of a retail facility may serve information to the users of the PDA 10. This may include both textual and audio information. Thus, audio or textual information about special sales, features or services may be broadcast to a variety of PDA 10 users. In addition, audio messages may be likewise forwarded through the intranet 31 and the audio transducers 20.

The software 38, stored on the storage 28 of the PDA 10 begins by detecting a card swipe as indicated in diamond 40 in FIG. 5 in accordance with one embodiment of the present invention. A user may be provided a PDA 10 when the user enters the retail facility. The user may authenticate and initiate the PDA 10 by a card swipe through the card reader 22. This immediately provides information about the user's identity without the need to use keys to enter text.

A local or remote database accessed by the server 34 may then provide data to authenticate and register the user and the user's PDA, as indicated in block 42. The database may contain information about the user including the user's name, password, and other codes. In addition, the database may include information about the user's interests, practices and past activities at the retail facility.

The position of the PDA 10 may then be automatically determined by polling the locating device 26. This information may be provided to the server 34 to locate the PDA as indicated in block 44. In one embodiment, a digital map may be displayed on the display 14, showing the layout of a particular retail store. The current position of the user, determined by the locating device 26, may then be displayed as an indication on the display 14.

In some embodiments, other personnel such as the user's friends or the store manager may likewise be identified at a position shown on the display 14. Other indications may be provided dynamically as well including the location of available check out cashiers and the location of sales personnel.

Once a PDA 10 has been authenticated on the intranet 31, located and registered, in some embodiments, communications may be immediately implemented. Both audible and text messages, for example using instant messaging, may be exchanged between various customers holding PDAs 10. In addition, customers may communicate with the retail facility, and particularly the server 34, to obtain additional information, such as product information. The retail facility may provide information to the users in response to user inquiries or as initiated by the retail facility owner or operator. This information may include information about special sales, or store hours as examples. Also music or video may be forwarded to interested customers.

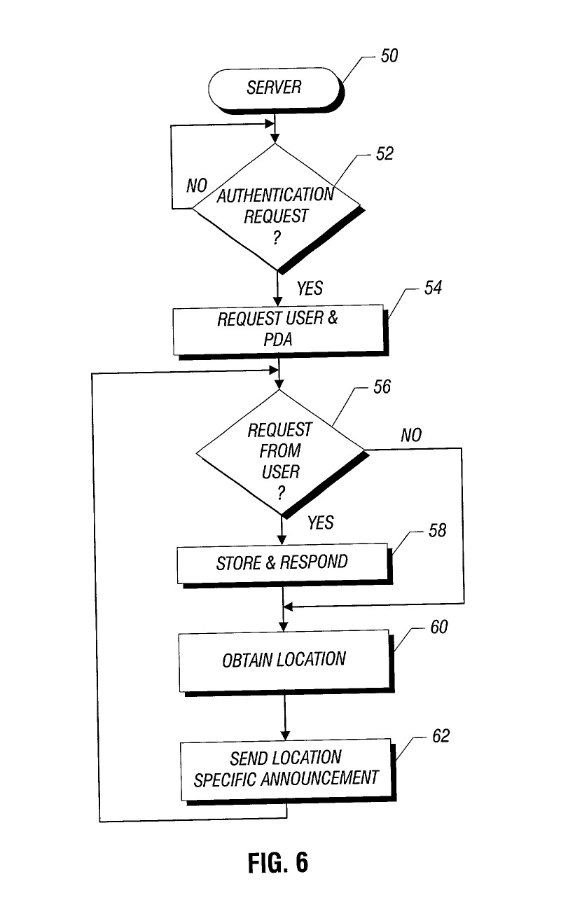

Referring next to FIG. 6, the server software 50, stored on the storage 36, may control the operation of the server 34 in accordance with one embodiment. The server software 50 receives an authentication request as indicated at diamond 52 from a PDA 10. In the response to such a request, the user's identity is compared to a database of preregistered users. The information from the user's card swipe may be utilized to identify the user and determine that the user is an authorized and registered user. Once the user has been recognized, as indicated in block 54, the user may be added to a database of active users. Users may allow their presence to be indicated to their friends who may also be located in the store. In such case, the server 34 may register the user and may provide links between a particular user and other users as preauthorized.

When the server 34 receives a user request, as determined in diamond 56, the information may be stored in a database associated with that user in order to obtain information about the user. The request may be responded to, as indicated in block 58, by providing information from the storage 34 or from the intranet, as desired.

If no request is forthcoming within a certain amount of time, the user's location may be obtained as indicated in block 60. This information may be obtained by providing a request to the PDA 10 and particularly its position locating device 26 for its current location. The server 34 then keeps track of the user's location so that the user may be identified on a digital display.

Based on the user's position, the user may receive personalized messages. For example, when the user is close to the plumbing department, the server 34 may provide advertising information relating to particular plumbing products. Thus, as indicated in block 62, location specific announcements may be provided to users either in response to user inquiries or as initiated by the server 34 itself.

Thus, in some embodiments, the PDA 10 may implement any function currently offered by processor-based devices. For example, the user may access, over the Internet, his or her own e-mail account or may access the Internet using a predefined Internet service provider account.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
wirelessly linking a plurality of customers within a retail facility through a local area network based in the retail facility; and
enabling customers to exchange information through said network.

2. The method of claim 1 wherein wirelessly linking includes providing wireless access to a server by a plurality of customers within a retail facility.

3. The method of claim 1 including providing a processor-based device to retail customers that wirelessly communicates with said server.

4. The method of claim 3 including enabling users to activate said device by swiping a credit card through a slot in said device.

5. The method of claim 1 including receiving audible communications from said customers.

6. The method of claim 1 including enabling customers to communicate via text messages with one another over said network.

7. The method of claim 1 including pushing electronic files to customers.

8. The method of claim 1 including providing information about the current location of a processor-based device associated with a customer.

9. The method of claim 8 including providing information about the customer's location to the server.

10. The method of claim 9 including pushing information to the customer depending on the customer's current location.

11. An article comprising a medium storing instructions that enable a processor-based system to:
wirelessly link a plurality of customers within a retail facility through a local area network based in the retail facility; and
enable customers to exchange information through said network.

12. An article of claim 11 further storing instructions that enable the processor-based system to be accessed wirelessly by a plurality of customers within a retail facility.

13. The article of claim 11 further storing instructions that enable the processor-based system to recognize a processor-based device used by a customer in response to a credit card swipe through a slot in said device.

14. The article of claim 11 further storing instructions that enable the processor-based system to receive audible communications from said customers.

15. The article of claim 14 further storing instructions that enable the processor-based system to broadcast audio files to said customers.

16. The article of claim 11 further storing instructions that enable the processor-based system to enable customers to communicate via text messages with one another over said network.

17. The article of claim 11 further storing instructions that enable the processor-based system to push electronic files to customers.

18. The article of claim 11 further storing instructions that enable the processor-based system to provide information about the current location of a processor-based device associated with a customer.

19. The article of 18 further storing instructions that enable the processor-based system to determine the customer's location.

20. The article of claim 19 further storing instructions that enable the processor-based system to push information to a customer depending on the customer's current location.

21. A system comprising:
a processor; and
a storage coupled to said processor to wirelessly link a plurality of customers within a retail facility through a local area network based in the retail facility and enable customers to exchange information through said network.

22. The system of claim 21 wherein said system is a server.

23. The system of claim 22 wherein said server is coupled to a wireless interface.

24. The system of claim 21 wherein said system maintains a network of wireless, processor-based devices used by customers.

25. The system of claim 24 wherein said system recognizes said processor-based device in response to the detection of a credit card swipe through a slot in one of said devices.
